(19) United States
(12) Patent Application Publication
(10) Pub. No.: US 2022/0095718 A1
(43) Pub. Date: Mar. 31, 2022

(54) External Brace for Enhancing Fit and Filtration Efficacy of Face Masks

(71) Applicant: The Board of Regents of the University of Oklahoma, Norman, OK (US)

(72) Inventors: Evan L. Floyd, Edmond, OK (US); Kenneth R. Marold, Norman, OK (US)

(73) Assignee: The Board of Regents of the University of Oklahoma, Norman, OK (US)

(21) Appl. No.: 17/486,475

(22) Filed: Sep. 27, 2021

Related U.S. Application Data
(60) Provisional application No. 63/083,282, filed on Sep. 25, 2020.

(51) Int. Cl. A41D 13/11

(52) U.S. Cl. CPC A41D 13/1161

(57) ABSTRACT

A frame is configured to improve the seal of a face mask worn on the face of a human. The frame generally includes one or more flexible pieces that conform to the human wearer's face. The frame compresses the face mask against the face of the human wearer. In some embodiments, the frame includes a nose section that conforms to the human's nose, a pair of cheek sections each extending laterally away from the nose section and across the human's cheek bones and downward toward the human's mandible, a plurality of strap anchors on the cheek sections, and one or more straps connected to the strap anchors on the cheek sections. The frame may also include a chin section that is unitary with the cheek sections, or a separate chin strap that is connected to the cheek sections with elastomeric bands.

### RELATED APPLICATIONS

This application claims the benefit of U.S. Provisional Patent Application Ser. No. 63/083,282 entitled “External Brace for Enhancing Fit and Filtration Efficacy of Face Masks,” filed Sep. 25, 2020, the disclosure of which is herein incorporated by reference.

### BACKGROUND

There is an emergent need for respirators that are useful for mitigating the inhalation and exhalation of viruses and bacteria. In addition to medical applications, there are a variety of industrial applications in which well-designed respirators will find particular utility. The present disclosure is directed at improving the performance of respirators to meet these medical and industrial needs.

A filtering face piece respirator (FFR) must have adequate filtration efficiency (e.g., greater than 95%) and fit the wearer well enough that less than 1% of inhaled air leaks into or bypasses the respirator instead of passing through the filter material. Inadequate face seals are a major limitation of surgical masks and many FFRs. Many face masks are designed to have a loose fit or otherwise improperly match the wearer's facial anthropometry. Most surgical masks fit slightly loose which allows 25-50% air leakage around the filtration material despite having greater than 95% filtration efficiency. Similarly, as noted in the PRIOR ART face mask 200 depicted in FIG. 1, many FFR respirators leave small gaps 202 along the nose bridge or cheek bones of the wearer 204 that can easily allow from 5 to 10% leakage, thereby preventing the face mask 200 from attaining the required 99% fit. There is, therefore, a need for a mechanism for improving the seal provided by FFRs. It is to these and other deficiencies in the prior art that embodiments of the present invention are directed.

### BRIEF DESCRIPTION OF THE DRAWINGS

FIG. 1 presents a PRIOR ART filtering face piece respirator (FFR).

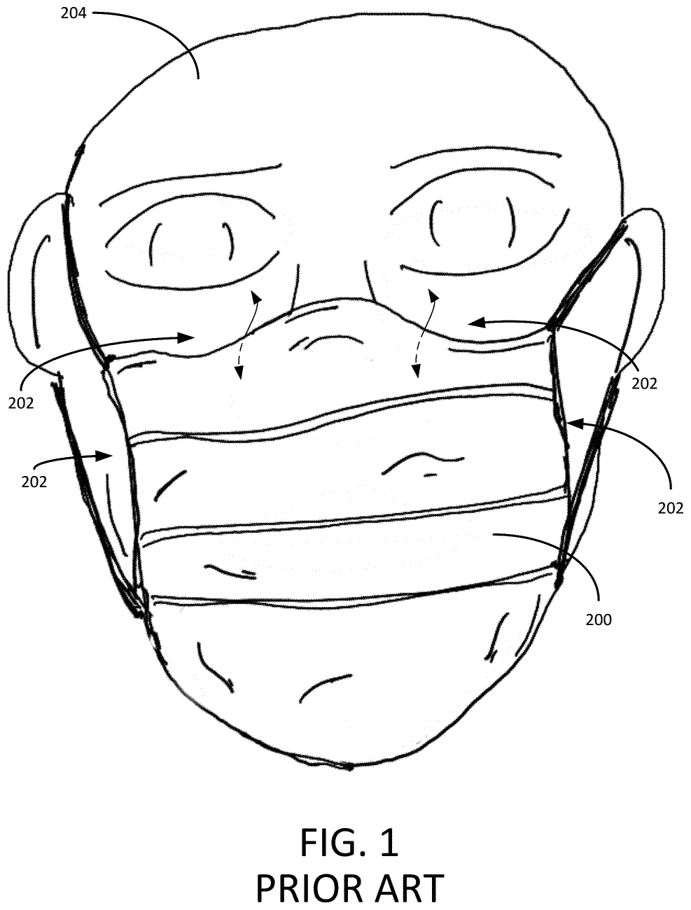

FIG. 2 presents a single piece frame for enhancing the function of the FFR of FIG. 1.

FIG. 3 presents a side perspective view of the single piece frame of FIG. 2.

FIG. 4 depicts the single piece frame being worn over a prior art FFR.

FIG. 5 presents a two piece frame for enhancing the function of the FFR of FIG. 1.

FIG. 6 depicts the two piece frame of FIG. 5 being worn over a prior art FFR.

FIG. 7 depicts the chin strap of the two piece frame of FIG. 5.

FIG. 8 presents an isolated view of the two piece frame of FIG. 5.

### DETAILED DESCRIPTION

The exemplary embodiments of the present disclosure are generally directed at a frame for improving the seal of a face mask worn on the face of a human. The frame generally includes one or more flexible pieces that conform to the human wearer's face. The frame compresses the face mask against the face of the human wearer. In some embodiments, the frame includes a nose section that conforms to the human's nose, a pair of cheek sections each extending laterally away from the nose section and across the human's cheek bones and downward toward the human's mandible, a plurality of strap anchors on the cheek sections, and one or more straps connected to the strap anchors on the cheek sections. The frame may also include a chin section that is unitary with the cheek sections, or a separate chin strap that is connected to the cheek sections with elastomeric bands.

Before further describing various embodiments of the present disclosure in more detail by way of exemplary description, examples, and results, it is to be understood that the embodiments of the present disclosure are not limited in structure and application to the details as set forth in the following description. The embodiments of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the present disclosure has been described in terms of particular embodiments, it will be apparent to those of skill in the art that variations may be applied to the apparatus and/or methods and in the steps or in the sequence of steps of the methods described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific, and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the apparatus, methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the terms “at least one” or “plurality” will be understood to include one as well as any quantity more than one, including but not limited to, 2, 3, 4, 5, 6, 7, 8, 9, 10, 15, 20, 30, 40, 50, 100, or any integer inclusive therein, and/or any range described herein. The terms “at least one” or “plurality” may extend up to 100 or 1000 or more, depending on the term to which it is attached; in addition, the quantities of 100/1000 are not to be considered limiting, as higher limits may also produce satisfactory results. In addition, the use of the term “at least one of x, y and z” will be understood to include x alone, y alone, and z alone, as well as any combination of x, y and z.

Where the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “a, b, c, or combinations thereof” is intended to include at least one of: a, b, c, ab, ac, bc, or abc, and if order is important in a particular context, also ba, ca, cb, cba, bca, acb, bac, or cab. Continuing with this example, expressly included are combinations that contain repeats of one or more item or term, such as bb, aaa, aab, bbc, aaabcccc, cbbaaa, cababb, and so forth. The skilled artisan will understand that typically there is no limit on the number of items or terms in any combination, unless otherwise apparent from the context.

Throughout this application, the terms “about” and “approximately” are used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, a temporal duration, thickness, width, length, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 75% of the time, at least 80% of the time, at least 90% of the time, at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The inventive concepts of the present disclosure will be more readily understood by reference to the following examples and embodiments, which are included merely for purposes of illustration of certain aspects and embodiments thereof, and are not intended to be limitations of the disclosure in any way whatsoever. Those skilled in the art will promptly recognize appropriate variations of the apparatus, compositions, components, procedures, and method shown below.

The accompanying figures present various embodiments of a frame 100 for improving the performance of the prior art respirator 200. The frame 100 is generally configured to be worn by a human wearer 204 over the outside of a prior art, commercially available FFR 200. The frame 100 is essentially a support structure that compresses and seals the filter material of the FFR 200 to the face of the wearer 204. The frame 100 is generally held over the outside of the FFR 200 with straps 102 that secure the frame 100 with a compressive force to the face of the wearer 204. The frame 100 is carefully designed to press the FFR 200 against the face of the wearer 204 to close the gaps 202 that might otherwise exist with a loose-fitting FFR 200. In testing, the frame 100 was found to drastically improve the fit quality of surgical masks from 50-75% to more than 95%, with some tests achieving greater than 99% fit. Similarly, the frame 200 increased the efficiency of a poorly fitting KN95 mask from 92% to about 98%.

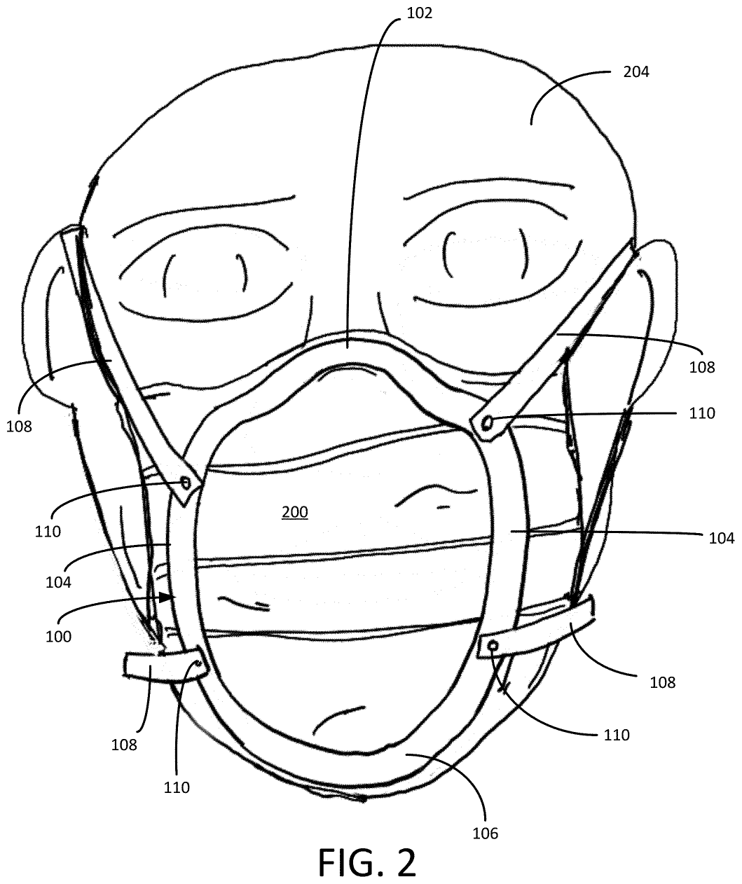

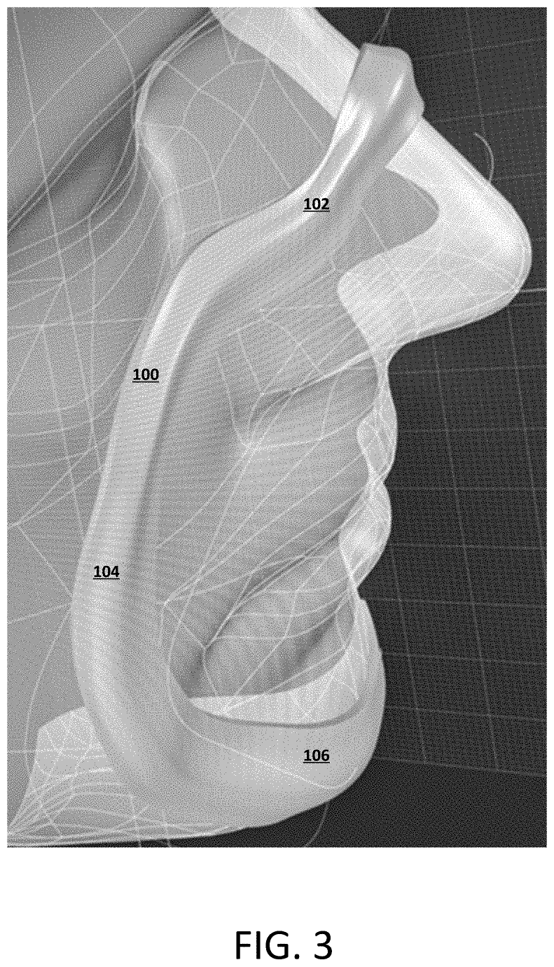

Turning to FIG. 2, shown therein is a one-piece embodiment of the frame 100 worn over a standard FFR 200. In this embodiment, the frame 100 is configured to conform to the facial features of the wearer 200 and includes a nose section 102, cheek sections 104 and a chin section 106. In the embodiment depicted in FIG. 2, the nose section 102, cheek sections 104 and chin section 106 are connected together through unitary construction. The nose section 102 fits across the nose with a contour that conforms closely with the transition from the wearer's nose to the wearer's cheek bones. The cheek sections 104 extend downward on both sides from the nose section 102 to the mandible of the wearer 204. The chin section 106 extends between both of the cheek sections 104 and is sized and configured to follow the jawline to the wearer's chin. The position of the frame 100 on the face of the wearer 204 is also depicted in FIG. 3.

The frame 100 is held in place by a plurality of straps 108 that are affixed to the frame 100 with anchors 110. The straps 108 and anchors 110 are preferably sized and configured such that the straps 108 are capable of applying a suitable sealing pressure to the FFR 200. In some embodiments, the straps 108 are manufactured from a similar polymeric material that exhibits suitable flexibility and tensile properties. In various embodiments, the straps 108 can be configured to connect around the back of the wearer's head and neck, or around the wearer's ears.

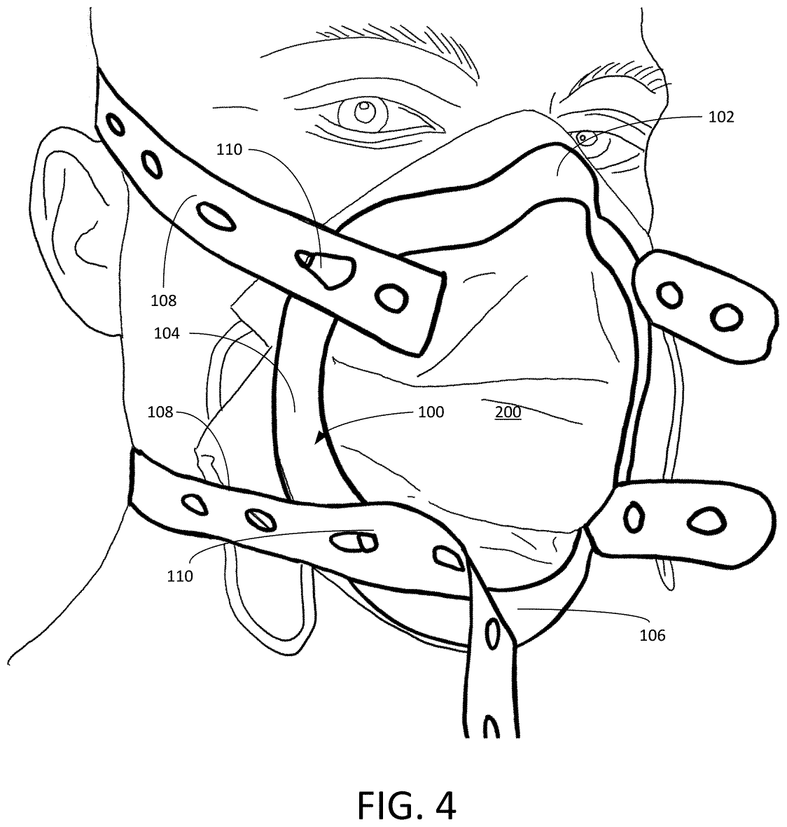

The anchors 110 can be manufactured as buttons, catches, or snaps that mechanically engage corresponding holes, latches, or buttons on the straps 108. In some embodiments, the straps 108 and frame 100 are configured such that the straps 108 can be positioned and connected to different portions of the frame 100. The anchors 110 can be repositioned on the frame 100 using a slide feature that can be locked into place with a ratcheting mechanism. In these embodiments, it may be useful to incorporate multiple anchors 110 in different locations around the frame 100. In yet other embodiments, the straps 108 are integral and unitary with the frame 100. Each strap 108 may include a clasp mechanism that permits the strap 108 to be connected and disconnected behind the wearer's head. In other embodiments, the straps 108 are continuous and configured to be removed by disconnecting the straps 108 from the anchors 110. The anchors 110 can be configured to engage with the ends of the straps 108 in a quick release clasping mechanism. FIG. 4 presents a photograph of a prototype of the frame 100 compressing a FFR 200 against the face of a wearer 204. The straps 108 have been cut to length once the proper fit is established.

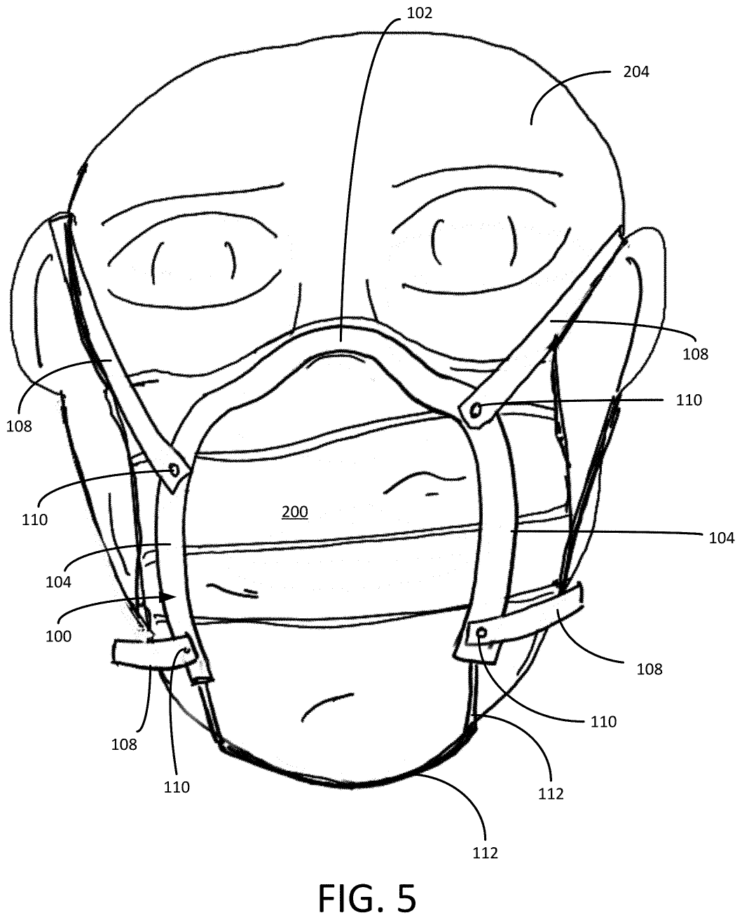

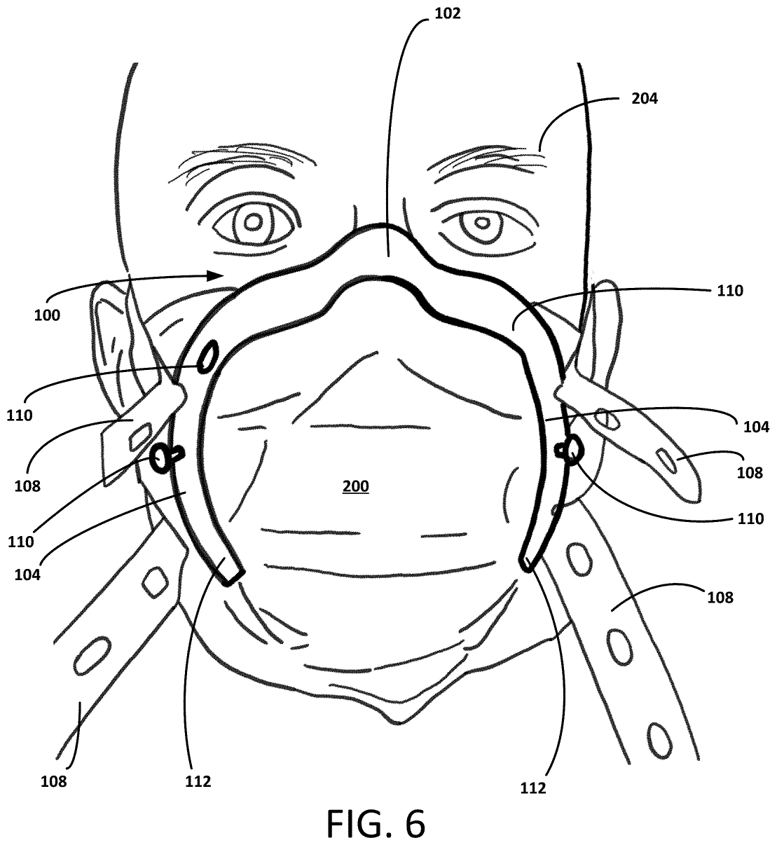

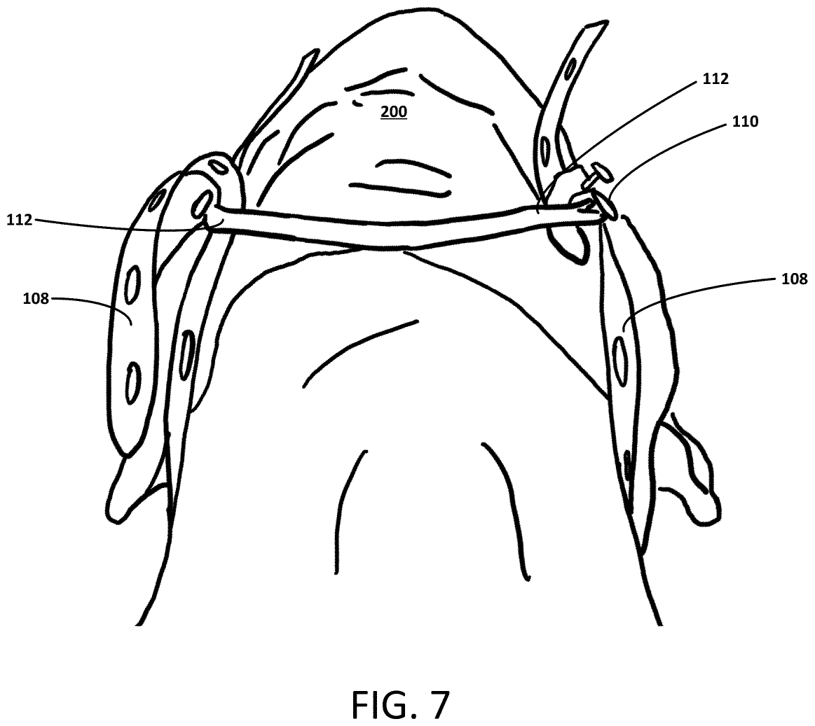

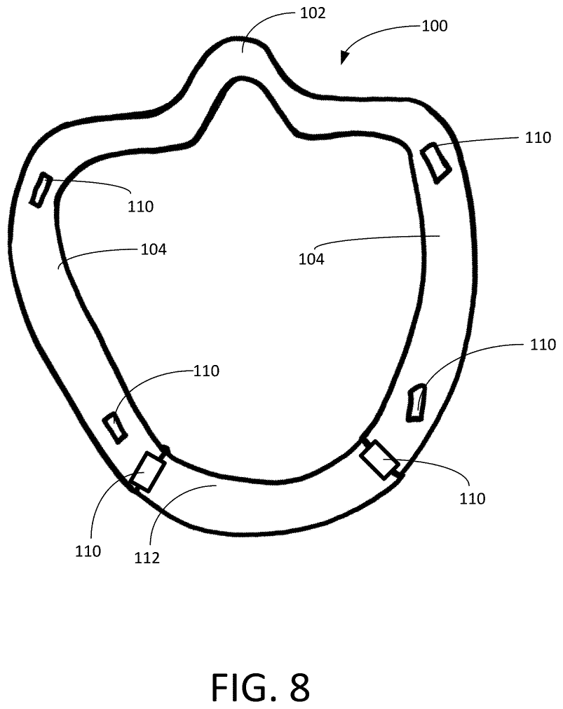

Turning to FIGS. 5-8, shown therein is an embodiment of the frame 100 in which the chin section 106 is not of unitary construction with the nose section 102 and cheek sections 104. In the embodiment depicted in FIGS. 5-8, the unitary chin section 106 has been replaced with a separate chin strap 112 that is secured to the ends of the cheek sections 104 with anchors 110. The chin strap 112 can be a silicone, rubber or elastomeric strap that is intended to fit under the chin of the wearer 204 to prevent the frame 100 from lifting on the wearer's face, while also permitting the wearer to speak more easily. The placement of the chin strap 112 is best seen in FIG. 7. Combining a rigid upper portion with an elastomeric lower (jaw) portion to achieve better fit and comfort is a significant advancement over prior art products.

In some embodiments, the chin strap includes a center piece that is connected on each end to a corresponding one of the cheek sections with a stretchable band, which cooperate to exert a tensile force between the center piece of the chin strap and the cheek sections of the frame. In some variations of this embodiment, the elastomeric chin strap 112 may not be necessary or desirable.

The frame 100 can be constructed from a semi-rigid polymer or composite material that is well-suited for maintaining a close fit with the contours of the wearer's face, while also comfortably applying pressure to the FFR 200 to close or reduce the gaps 202. In some embodiments, the frame 100 is constructed using a heat molding process in which a thermoplastic is softened with heat and then conformed to the face of the wearer 204. In other embodiments, the wearer's face is scanned to produce a digital 3D model. A model of the frame 100 can then be created to closely match the contours of the wearer's face. In these embodiments, the frame 100 may be constructed using additive manufacturing processes based on the 3D model created for the frame 100.

In yet other embodiments, a set of standard fit test frames 100 is used as a starting point for customizing a frame 100 for a particular wearer. Anthropometric data (both 2D and 3D) from The National Institute for Occupational Safety and Health (NIOSH) can be used to create the standard fit panel of frames. In these embodiments, the frame 100 can be manufactured from a material or combination of materials that permit the frame 100 to be easily conformed to the unique contours of the wearer's face. For example, the frame 100 can be constructed of a flexible polymer that encases a bendable, ductile metal strip.

Although dimensions and spacing of the frame 100 are presented in the accompanying illustrations, it will be appreciated that the frame 100 may be configured in a different orientation. For example, the cheek sections 104 may be positioned closer to the wearer's mouth to form a “cup-like” enclosure around the FFR 200. The frame 100 may include, for example, a frame that contours over the nose section 102, around the nose and mouth such that the cheek sections 104 form a narrow shape, down to the sides of the chin and terminates at the sides of the chin. This embodiment may or may not have an elastomeric chin strap 112 that continues under the jaw.

It will also be appreciated that the frame 100 may be formed of a material with a uniform or variable thickness and width. Variable width and thickness are expected to provide the greatest ability to contour and mold the frame to the wearer 204, but may not be necessary or desirable in some applications.

In other applications, the frame 100 may be provided with one or more separate gasket pieces that are positioned between the frame 100 and the FFR 200. The gasket can be designed with variable thickness material or simple curved spring that will bridge any gaps 202 between the frame 100 and the wearer's face. The gasket may have a similar construction to the frame 100, but extend beyond the ends of the cheek sections 104 to form the chin strap 112 that extends under the jaw or chin. The chin-strap gasket may be removable from the frame 100. The gasket pieces can be constructed from a compressible foam that is secured to the underside of the frame 100 with adhesives.

In some embodiments, the chin section 106 and lower cheek sections 104 are detachable from the balance of the frame 100. This embodiment may be desired to provide better fit or greater comfort to the wearer.

In yet another embodiment, the frame 100 may include a single head strap 108 that is connected around the back of the wearer's head to anchors 110 on opposite sides of the frame 100. The anchors 110 can be of any construction, such as a knob on a post, flat square tab, curved hook, cylinder, two-bar friction channel, or any such similar embodiment of a simple direct connection of the strap 108 directly to the frame 100. The use of multiple head straps 108 is also contemplated as within the scope of these exemplary embodiments. The use of multiple straps 108 may improve comfort, quality, and security of the fit of the frame 100 for different facial anthropometry, hair styles and other protective equipment worn by the wearer. For example, a wearer 204 with a high nose may find that tension from a single strap 108 tends to slide the mask frame 100 up their face and into their eyes over time, especially if they wear their hair in a ponytail and place the head strap 108 above the pony tail. This wearer 204 is likely to need a second strap 108 attached lower on the frame 100 and looping behind their neck to retain the frame 100 in the desired position.

Similarly, someone with a low nose may find that the head strap 108 passes on top of their ears and as a result wear the strap 108 over the crown of their head to avoid this. This wearer would also likely need a second lower strap 108 behind their neck to keep the frame 100 from lifting up over time. Additionally, having multiple connection points allows each wearer 204 to customize the fit of the frame 100 so that pressure is uniformly applied through the frame 100 to maintain a seal between the mask 200 and the face. Different faces and habits of wearing are likely to warrant multiple strap anchors 110 to attain maximum effectiveness and comfort.

Thus, the embodiments of the present disclosure are well adapted to carry out the objects and attain the ends and advantages mentioned above, as well as those inherent therein. While the inventive device and system have been described and illustrated herein by reference to particular non-limiting embodiments in relation to the drawings attached thereto, various changes and further modifications, apart from those shown or suggested herein, may be made therein by those of ordinary skill in the art, without departing from the spirit of the inventive concepts.

What is claimed is:

1. A frame for improving the seal of a face mask worn on the face of a human, the frame comprising:
a nose section that conforms to the human's nose;
a pair of cheek sections each extending laterally away from the nose section and across the human's cheek bones and downward toward the human's mandible;
a plurality of strap anchors on the cheek sections; and
one or more straps connected to the strap anchors on the cheek sections.

2. The frame of claim 1, further comprising a unitary chin section extending from distal ends of the cheek sections.

3. The frame of claim 1, further comprising a separate chin strap removably connected to distal ends of the cheek sections.

4. The frame of claim 1, wherein the nose section and cheek sections are manufactured from a unitary piece of thermoform plastic that can be heat molded to match contours of the human's face.

5. The frame of claim 1, wherein the frame is constructed using additive manufacturing based on a 3D model of the human's face.

6. The frame of claim 1, further comprising one or more gasket pieces connected to an underside of the frame.

7. The frame of claim 6, wherein the gasket pieces comprise flexible foam pieces secured to the frame with adhesives.

8. A frame for improving the seal of a face mask worn on the face of a human, the frame comprising:
a nose section that conforms to the human's nose;
a pair of cheek sections each extending laterally away from the nose section and across the human's cheek bones and downward toward the human's mandible;
a chin section extending from distal ends of the cheek sections;
a plurality of strap anchors on the cheek sections; and
one or more straps connected to the strap anchors.

9. The frame of claim 8, wherein the nose section, the pair of check sections and the chin section are constructed as a unitary component.

10. The frame of claim 9, wherein the nose section, cheek sections and chin section are manufactured from a unitary piece of thermoform plastic that is heat molded to match contours of the human's face.

11. The frame of claim 8, wherein the frame is constructed using additive manufacturing based on a 3D model of the human's face.

12. The frame of claim 8, further comprising one or more gasket pieces connected to an underside of the frame.

13. The frame of claim 12, wherein the gasket pieces comprise flexible foam pieces secured to the frame with adhesives.

14. A frame for improving the seal of a face mask worn on the face of a human, the frame comprising:
a nose section that conforms to the human's nose;
a pair of cheek sections each extending laterally away from the nose section and across the human's cheek bones and downward toward the human's mandible;
a separate chin strap removably connected to distal ends of the cheek sections;
a plurality of strap anchors on the cheek sections; and
one or more straps connected to the strap anchors.

15. The frame of claim 14, wherein the nose section and the pair of cheek sections are constructed as a unitary component.

16. The frame of claim 15, wherein the nose section and cheek sections are manufactured from a unitary piece of thermoform plastic that is heat molded to match contours of the human's face.

17. The frame of claim 14, wherein the chin strap comprises a silicone strap that fits under the chin of the human.

18. The frame of claim 14, wherein the chin strap comprises a center piece configured to fit under the chin of the human that is connected on each end to a corresponding one of the cheek sections with a stretchable band that together exert a tensile force between the center piece of the chin strap and the cheek sections of the frame.

19. The frame of claim 14, wherein the nose section and the cheek sections are constructed from a flexible elastomeric material with an embedded ductile metal strip.

20. The frame of claim 14, wherein the nose section and the cheek sections are constructed from a flexible elastomeric material that has a variable thickness across the length of the nose section and the check sections.
